(19) United States
(12) Patent Application Publication
(10) Pub. No.: US 2026/0160949 A1
(43) Pub. Date: Jun. 11, 2026

(54) OPTICAL FIBER ROTATOR, FUSION SPLICER, AND OPTICAL FIBER HOLDER

(71) Applicant: Lightera Japan Co., Ltd., Tokyo (JP)

(72) Inventor: Akio Tanabe, Tokyo (JP)

(21) Appl. No.: 19/538,143

(22) Filed: Feb. 12, 2026

Related U.S. Application Data
(63) Continuation of application No. PCT/JP2025/029780, filed on Aug. 25, 2025.

(30) Foreign Application Priority Data
Aug. 27, 2024 (JP) 2024-145755

(51) Int. Cl. G02B 6/255

(52) U.S. Cl. CPC G02B 6/2555; G02B 6/2553

(57) ABSTRACT

An optical fiber holder is used in a fusion splicer that includes a rotator for rotational alignment of an optical fiber. The holder serves as an optical fiber holding portion for holding the fiber. When a lid portion is closed onto a main body, gear portions, in which a plurality of teeth are arranged in a circumferential direction over a substantially entire circumference of an outer periphery surface of the holder, are formed. A motor meshes with the gear portions of the holder via a gear connecting the motor to the gear portions of the holder. At least one of the holders for a pair of fibers, which are disposed facing each other, is held by the rotator and is rotated with axial directions of the fibers as a rotation axis, such that positions of end faces of the fibers can be aligned to each other in the circumferential direction.

### TECHNICAL FIELD

The present invention relates to an optical fiber rotator for rotational alignment of an optical fiber, and the like.

### BACKGROUND

Fusion splicers are used to connect optical fibers together. In a fusion splicer, optical fibers held by a pair of holders are butted to each other and disposed between electrodes, and tips of the optical fibers are fused together by an arc generated between the electrodes so that the optical fibers are connected to each other.

When fusion splicing optical fibers to each other, an alignment operation for aligning tip positions of the optical fibers is necessary. Thus, conventionally, alignment has been performed by disposing the optical fibers facing each other and capturing, using an image capturing portion, images of the tip positions of the optical fibers from a side (from a direction perpendicular to axial directions of the optical fibers).

However, when the optical fiber is not a typical single-core optical fiber but has a circumferential direction relative to a cross-sectional shape thereof, such as a polarization-maintaining optical fiber or a multi-core optical fiber, alignment is required not only at the tip position but also in a rotational direction. That is, it is necessary to perform not only alignment of the tip positions of the optical fibers in a so-called X-Y direction but also rotational alignment in the circumferential direction with the axial direction of the optical fibers as a center axis.

For such the rotational alignment of optical fibers, Japanese Patent Application Laid-Open Application No. 2005-164985 (JP-A-2005-164985), for example, has proposed an optical fiber rotator having an axis portion formed with a fiber groove in which an optical fiber is to be disposed, and a mounting portion on which a tip of the optical fiber is mounted with the tip being directed toward an end portion opposing the axis portion, in which a support portion supports the axis portion and a rotating member can rotate around an axis of the optical fiber.

### SUMMARY OF THE DISCLOSURE

FIG. 9A is a schematic view showing a structure of a conventional rotator 100. A holder mounting portion 109 is fixed to a butting portion 111 of the rotator 100. The holder mounting portion 109 is a part on which an optical fiber holder that holds an optical fiber is to be mounted. The butting portion 111 is disposed on a support portion 103 fixed to a fusion splicer via an axis-receiving member 101. A gear portion 105 is disposed on a rear side of the butting portion 111. The gear portion 105 is fixed to the butting portion 111 by a stopping member 107 that is disposed on a rear side of the gear portion 105.

The gear portion 105 is connected to a motor (not shown) via a gear. That is, the motor can rotate the gear portion 105. By rotating the gear portion 105 by the motor in this way, the holder mounting portion 109 rotates relative to the support portion 103.

FIG. 9B is a view showing a state in which an optical fiber holder 113 holding an optical fiber 115 is disposed on the holder mounting portion 109. A right side of the drawing is a facing direction toward another optical fiber, which is a connection target. By disposing the optical fiber 115 in this way and by rotating the holder mounting portion 109 with an axis direction of the optical fiber 115 as a rotation axis as shown in FIG. 9C (in a direction of an arrow X in the drawing), rotational alignment of the optical fiber 115 can be performed.

Here, in some cases, an optical module may be connected to a rear end side of the optical fiber 115 to be connected as the connection target (an end portion on a left side in the drawing), for example. To connect such the optical fiber 115 attached with the optical module, it is necessary, at least, to dispose the optical module outside the rotator 100 (the fusion splicer). Thus, from the rear end of the optical fiber holder 113 up to the optical module, the optical fiber 115 needs to have an extra length that is at least equal to a length of the rotator 100 (Y in the drawing).

For this reason, when the extra length of the optical fiber 115 is short, it may be impossible to set the optical fiber 115 in the rotator and it may not be possible to perform connection operation. Also, when quality of a connected portion is insufficient after fusion splicing, it may be necessary to cut the connected portion once and to perform the fusion splicing again. However, in such the case, since the length of the optical fiber 115 becomes shorter than that at the time of the initial connection operation, it may be impossible to set the optical fiber 115 in the fusion splicer as mentioned above and to be connected through rotational alignment. In such the case, the optical fiber 115 attached with the optical module has to be discarded.

The present invention was made in view of such problems. It is an object of the present invention to provide a compact optical fiber rotator, and the like.

To achieve the above object, a first aspect of the present invention is an optical fiber rotator including an optical fiber holding portion for holding an optical fiber, a gear portion formed on an outer periphery surface of the optical fiber holding portion, and a driving portion that is capable of rotating the gear portion. The optical fiber rotator is capable of rotating the optical fiber holding portion with an axis direction of the optical fiber as a rotation axis.

The optical fiber holding portion may be an optical fiber holder having a main body and a lid portion. The optical fiber may be held by being disposed in the main body and by closing the lid portion. The gear portion may be provided on an outer periphery surface of the optical fiber holder.

The optical fiber holding portion may be capable of accommodating therein the optical fiber holder for holding the optical fiber, and it may be possible to rotate the optical fiber holder together with the optical fiber holding portion.

The optical fiber holding portion may include a holding-portion main body and a holding-portion lid, and it may be possible to open and close the holding-portion lid with respect to the holding-portion main body.

According to the first aspect of the present invention, the gear portion is formed on the outer periphery portion of the optical fiber holding portion for holing the optical fiber, and thus there is no need to dispose the gear portion at the rear of the optical fiber holding portion as in conventional cases. Thus, compared to a case in which the optical fiber rotator is disposed at the rear of the optical fiber holding portion, a length of the optical fiber required at the rear of the optical fiber holding portion can be reduced. Thus, an optical fiber with a short length may be applicable.

Also, if the optical fiber holding portion having the gear portion is itself an optical fiber holder, the optical fiber can be easily installed in the optical fiber holding portion.

Also, since the optical fiber holding portion having the gear portion can accommodate therein the optical fiber holder, a conventional optical fiber holder can be used as is.

In such the case, installing the optical fiber holder is easy since the optical fiber holding portion includes the holding-portion main body and the holding-portion lid and the holding-portion lid can be opened and closed with respect to the holding-portion main body.

A second aspect of the present invention is a fusion splicer equipped with the optical fiber rotator according to the first aspect of the present invention. In the fusion splicer, at least one of a pair of optical fibers that are disposed facing each other is held by the optical fiber rotator, and an axis receiving portion supports the optical fiber holding portion to a fusion-splicer main body.

The driving portion may be disposed on a fusion-splicer lid that can be opened and closed with respect to the fusion-splicer main body. The driving portion and the gear portion of the optical fiber holding portion may be connected to each other by closing the fusion-splicer lid.

According to the second aspect of the present invention, rotational alignment and fusion splicing can be performed even on short optical fibers.

Also, by providing a motor on a lid-portion side of the fusion splicer and closing the lid portion of the fusion splicer, the motor and the gear portion can be easily connected and interlocked.

A third aspect of the present invention is an optical fiber holder that is capable of holding an optical fiber. The optical fiber holder includes a main body on which the optical fiber is to be disposed, and a lid portion that can be opened and closed with respect to the main body. When the lid portion is closed onto the main body, a gear portion in which a plurality of teeth are arranged in a circumferential direction is formed on outer periphery surfaces of the main body and the lid portion.

According to the third aspect of the present invention, since the gear portion is formed on the outer periphery portion of the optical fiber holder, there is no need to form the gear portion at the rear of an optical fiber holder mounting portion of the fusion splicer. Thus, even a short optical fiber can be set into the fusion splicer.

The present invention can provide a compact optical fiber rotator, and the like.

### BRIEF DESCRIPTION OF DRAWINGS

FIG. 1 is a perspective view showing an optical fiber holder 1 being closed.

FIG. 2A is a side view showing the optical fiber holder 1 being closed.

FIG. 2B is a plan view showing the optical fiber holder 1 being closed.

FIG. 3 is a perspective view showing the optical fiber holder 1 being opened.

FIG. 4A is a side view showing the optical fiber holder 1 being opened.

FIG. 4B is a plan view showing the optical fiber holder 1 being opened.

FIG. 5A is a view showing a step of setting the optical fiber holder 1 to a fusion splicer.

FIG. 5B is a view showing a step of setting the optical fiber holder 1 to the fusion splicer.

FIG. 5C is a view showing a step of setting the optical fiber holder 1 to the fusion splicer.

FIG. 6A is a view showing a state in which axis portions 5a and 5b are interposed and fixed between receiving portions 23a and 23b.

FIG. 6B is a view showing a state in which the axis portions 5a and 5b are interposed and fixed between the receiving portions 23a and 23b.

FIG. 7 is a view showing a state before setting an optical fiber holder 39 into an optical fiber holding portion 1a.

FIG. 8A is a view showing a state in which the optical fiber holder 39 is set into the optical fiber holding portion 1a.

FIG. 8B is a view showing a state in which a holding-portion lid 11a of the optical fiber holding portion 1a is closed.

FIG. 9A is a schematic view showing a structure and a method of using a conventional rotator 100.

FIG. 9B is a schematic view showing the structure and the method of using the conventional rotator 100.

FIG. 9C is a schematic view showing the structure and the method of using the conventional rotator 100.

### DETAILED DESCRIPTION

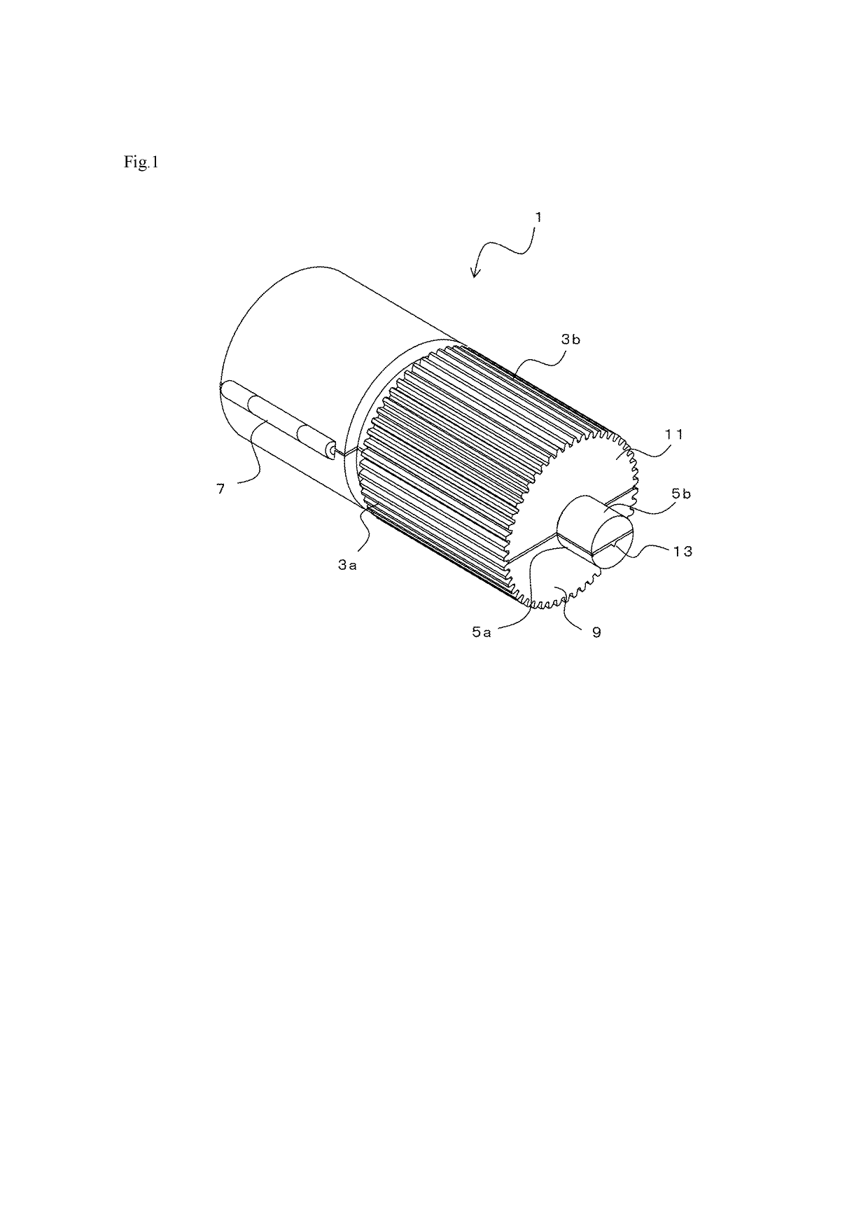

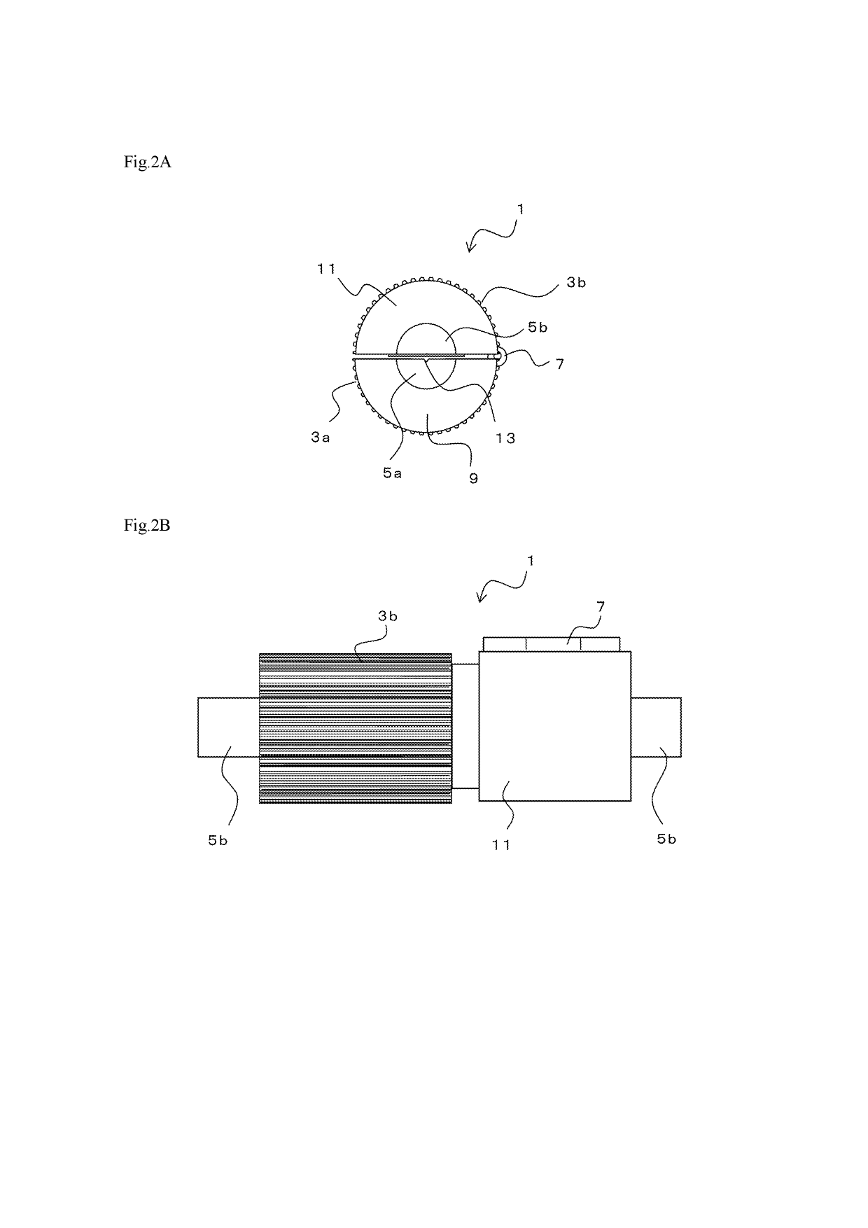

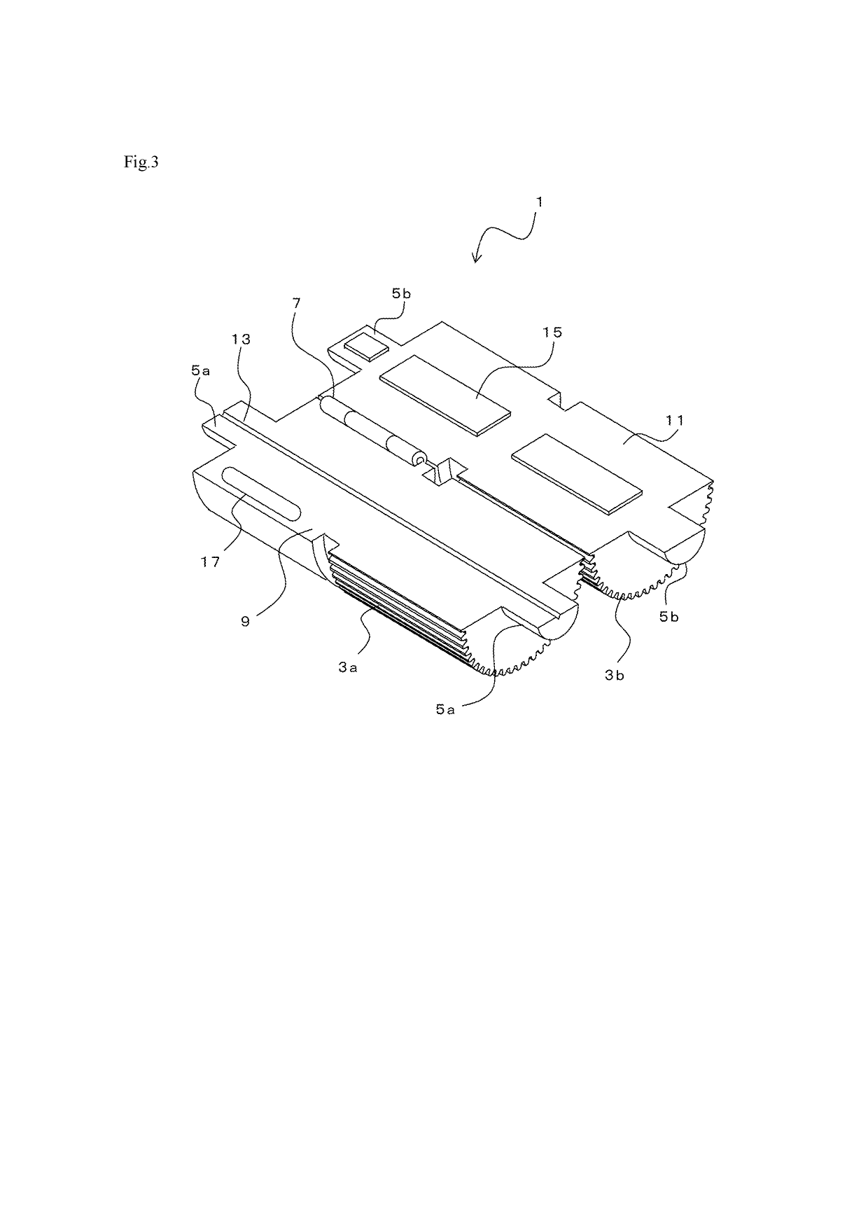

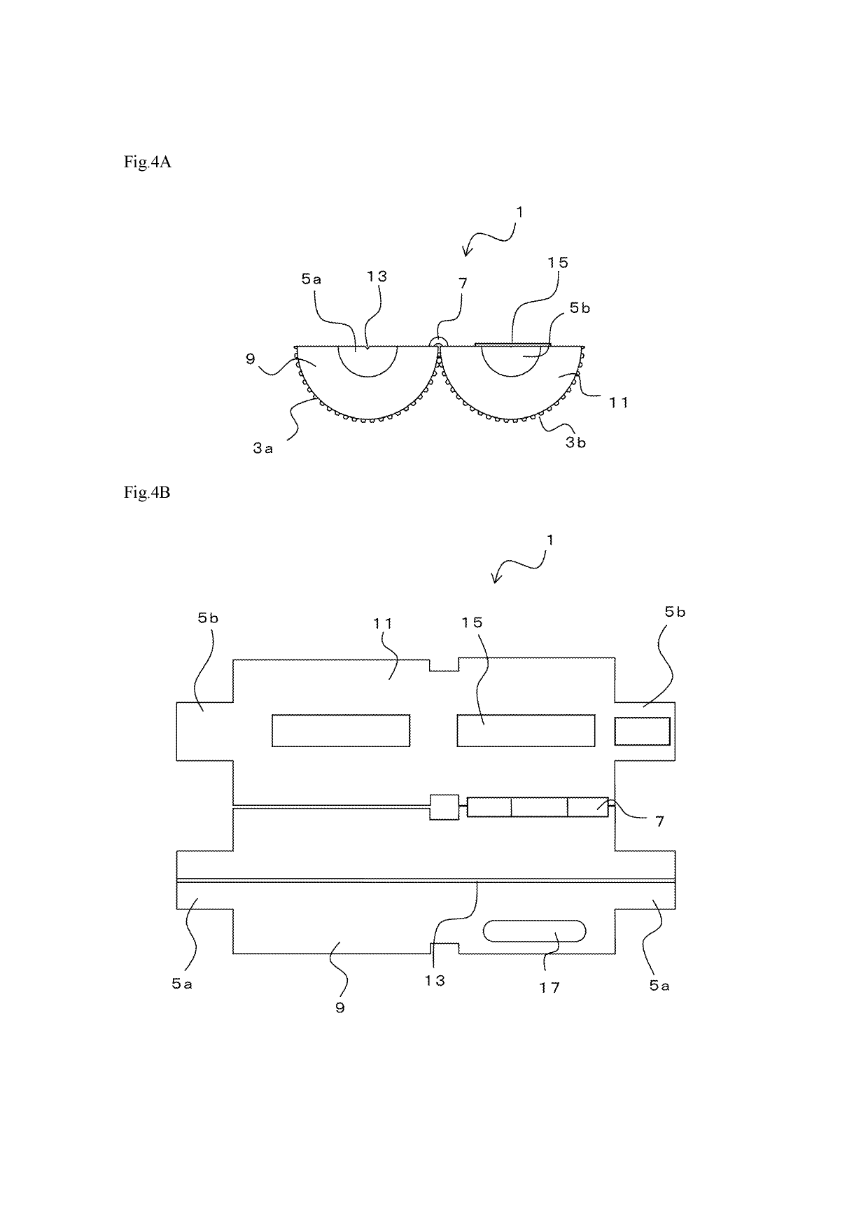

Hereinafter, embodiments of the present invention will be described with reference to the accompanying drawings. FIG. 1 is a perspective view showing an optical fiber holder 1 being closed, FIG. 2A is a side view of the optical fiber holder 1 being closed, and FIG. 2B is a plan view of the optical fiber holder 1 being closed. Also, FIG. 3 is a perspective view showing the optical fiber holder 1 being opened, FIG. 4A is a side view of the optical fiber holder 1 being opened, and FIG. 4B is a plan view of the optical fiber holder 1 being opened.

The optical fiber holder 1 is used in a fusion splicer that has a rotator for rotationally aligning an optical fiber. That is, in the fusion splicer, the optical fiber holder 1 serves as an optical fiber holding portion for holding the optical fiber. The optical fiber holder 1 includes a main body 9 and a lid portion 11, each having a half-split shape, and the main body 9 and the lid portion 11 are joined by a hinge 7. That is, the lid portion 11 can be opened and closed with respect to the main body 9 by the hinge 7, and, when the main body 9 and the lid portion 11 are closed, the optical fiber holder 1 has a substantially cylindrical shape.

An axis portion 5a is formed at each end of an axial direction of the main body 9 and an axis portion 5b is formed on each end portion of an axial direction of the lid portion 11. When the main body 9 and the lid portion 11 are closed, the axis portion 5a and the axis portion 5b face each other to form a cylindrical axis shape. That is, the optical fiber holder 1 has a substantially cylindrical shape when being closed, and each axis portion protrudes on each end portion of an axial direction of the cylindrical shape.

As shown in FIG. 3 and FIG. 4B, a magnet 17 is disposed on an upper surface of the main body 9. When the lid portion 11, which is a magnetic body, is closed with respect to the main body 9, the lid portion 11 is attracted to the magnet 17 and is held in a closed state with respect to the main body 9. The main body 9 and the lid portion 11 may not be joined by the hinge 7. Also, instead of using the magnet 17, another method may be used to hold the main body 9 and the lid portion 11 in the closed state.

A V-groove 13 is formed on the upper surface of the main body 9. The optical fiber can be disposed in the V-groove 13. Also, a pressing member 15 is provided on a lower surface of the lid portion 11 corresponding to the V-groove 13. The pressing member 15 is made of rubber, for example. When the lid portion 11 is closed, the pressing member 15 can press the optical fiber disposed in the V-groove 13. That is, by closing the lid portion 11 in a state in which the optical fiber is disposed in the main body 9, the optical fiber can be held by the optical fiber holder 1.

An outer periphery surface of the main body 9 is provided, at least partly in the axial direction thereof, with a gear portion 3a having a plurality of teeth. Also, an outer periphery surface of the lid portion 11 is provided, at least partly in the axial direction thereof, with a gear portion 3b having a plurality of teeth. When the lid portion 11 is closed with respect to the main body 9, a gear having the plurality of teeth arranged in a circumferential direction over a substantially entire circumference of an outer periphery surface of the optical fiber holder 1 is formed. Note that a center axis of the gear formed by the gear portions 3a and 3b coincides with an axis of the optical fiber being held.

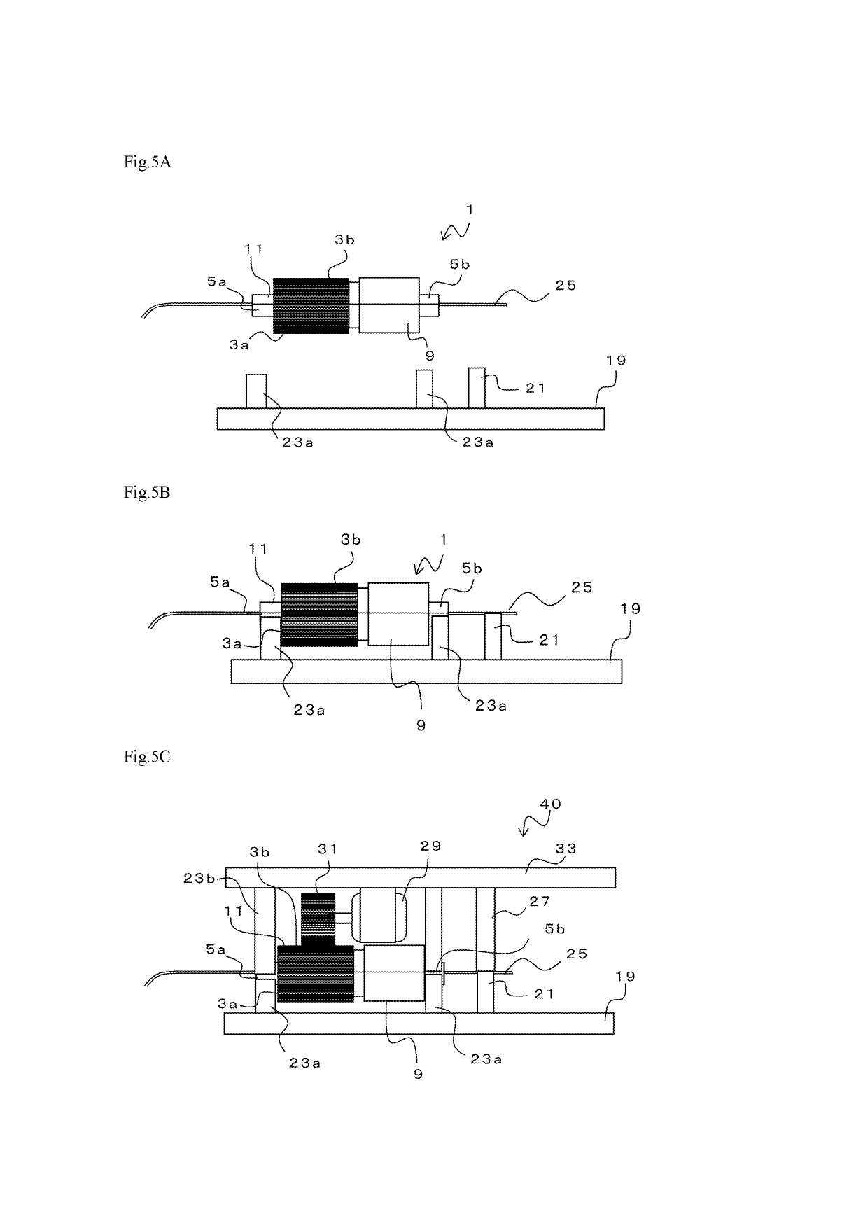

Next, a method of using the optical fiber holder 1 will be described. FIG. 5A is a schematic view showing a state before setting the optical fiber holder 1 in a fusion-splicer main body 19, and FIG. 5B is a view showing a state in which the optical fiber holder 1 is set in the fusion-splicer main body 19. A pair of receiving portions 23a are disposed being apart at a predetermined interval in the fusion-splicer main body 19, and a V-groove 21 is provided in front of the receiving portions 23a.

The receiving portions 23a are parts for supporting the axis portions 5a and 5b at both ends of the optical fiber holder 1. As shown in FIG. 5B, the optical fiber holder 1 is disposed on the receiving portions 23a, and an optical fiber 25 protruding from a tip end of the optical fiber holder 1 is set into the V-groove 21.

FIG. 5C is a view showing a rotator 40 for an optical fiber in a state in which a fusion-splicer lid 33, which can be opened and closed with respect to the fusion-splicer main body 19, is closed. On the fusion-splicer lid 33, receiving portions 23b are disposed at positions corresponding to the receiving portions 23a. Thus, as shown in FIG. 5C, the receiving portions 23b disposed on the fusion-splicer lid 33 and the receiving portions 23a of the fusion-splicer main body 19 can hold the axis portions 5a and 5b of the optical fiber holder 1.

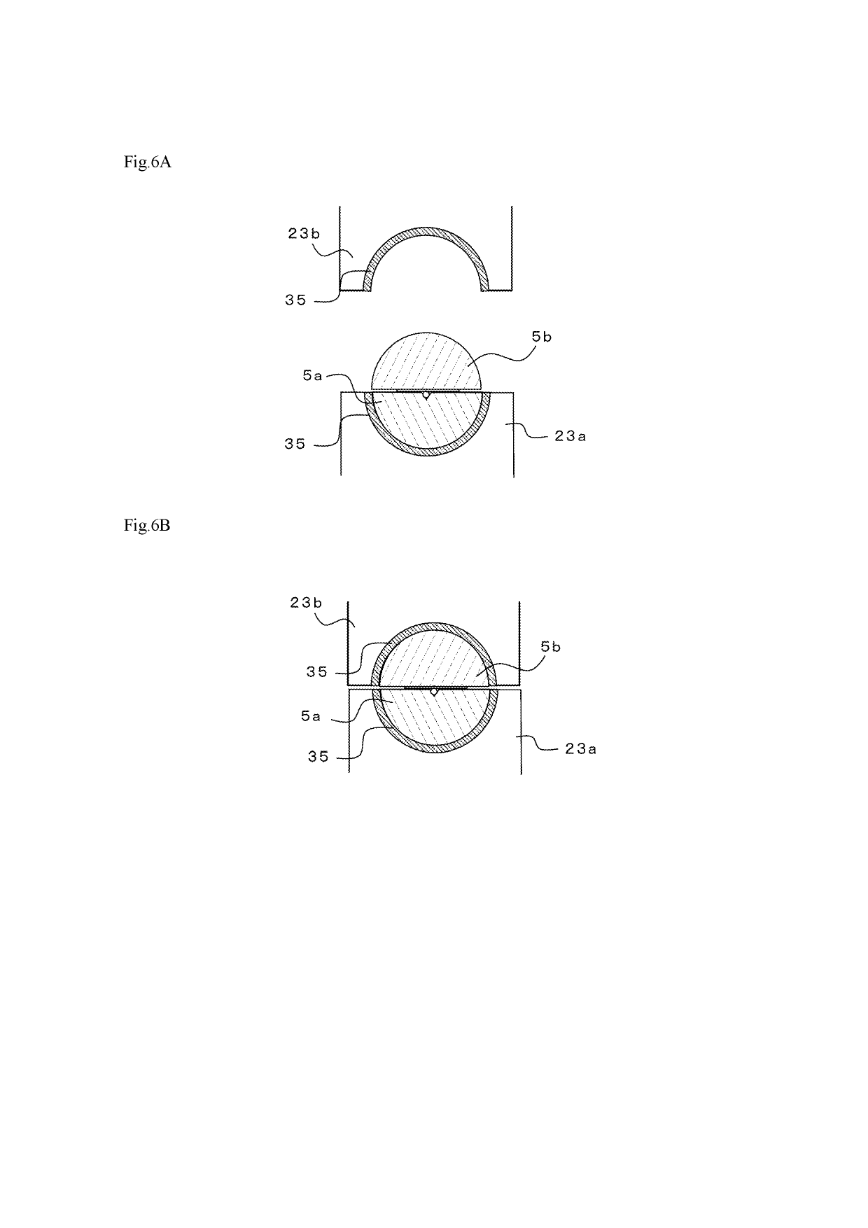

FIG. 6A and FIG. 6B are views showing a state in which the axis portions 5a and 5b are interposed and held between the receiving portions 23a and 23b. In the present embodiment, axis-receiving members 35 are disposed on inner periphery surfaces of the receiving portions 23a and 23b. The axis-receiving member 35 is formed of, for example, a low-friction member having a small friction coefficient with respect to the receiving portions 23a and 23b. In this way, the receiving portions 23a and 23b support the optical fiber holder 1 with respect to the fusion-splicer main body 19, and thus the optical fiber holder 1 can be supported rotatably with the axis portions 5a and 5b as a rotation axis.

Also, as shown in FIG. 5C, on the fusion-splicer lid 33, a clamp 27 is disposed at a part corresponding to the V-groove 21. Thus, when the fusion-splicer lid 33 is closed, the clamp 27 presses the optical fiber 25 disposed in the V-groove 21 from above, thereby holding the optical fiber 25.

Also, in the present embodiment, a motor 29 is disposed on the fusion-splicer lid 33. By closing the fusion-splicer lid 33, the motor 29 meshes with the gear portions 3a and 3b of the optical fiber holder 1 via a gear 31, and the motor 29 is connected to the gear portions 3a and 3b of the optical fiber holder 1. That is, the motor 29 serves as a driving portion for rotating the optical fiber holder 1 (the gear portions 3a and 3b). Alternatively, instead of on the fusion-splicer lid 33, the motor 29 may be disposed on a side of the fusion-splicer main body 19. Also, depending on an arrangement or the like of the motor 29, driving force from the motor 29 may be transmitted to the optical fiber holder 1 (the gear portions 3a, 3b) via another idler gear.

When performing a rotational alignment, firstly, images of end faces of a pair of the optical fibers 25 disposed facing each other are taken by a reflection member or the like (not shown). Next, the rotator 40 holds the optical fiber holder 1 of at least one of the pair of the optical fibers 25 facing each other, and the optical fiber holder 1 is rotated with the axial direction of the optical fiber 25 as the rotation axis. In this way, positions of the end faces of the optical fibers 25 in the circumferential direction can be aligned.

Although FIG. 5C shows the rotator 40 on one optical fiber side of the fusion splicer, the other side may have a symmetrical structure, or the rotational alignment may be performed only by the rotator 40 on the one side without providing a rotator on the other side.

A conventional X-Y direction alignment operation can be performed in the same way as a conventional method. After the alignment, the reflecting member is retracted, and arc discharge is generated between electrodes (not shown) and the pair of optical fibers 25 are butted together, thereby performing rotational alignment and fusion splicing of the optical fibers 25.

As above, according to the present embodiment, since the gear portions 3a and 3b are formed on the outer periphery surface of the optical fiber holder 1 and the gear portions 3a and 3b are rotated by the driving portion, the optical fiber holder 1 can be used in place of a conventionally used optical fiber holder. Thus, the optical fiber holder 1 can be used in a procedure that is similar to the conventional one.

Also, since the gear is formed on the outer periphery surface of the optical fiber holder 1, compared to the conventional case where a rotator is provided at the rear of the optical fiber holder 1, the extra length of the optical fiber 25 required at the rear of the optical fiber holder 1 can be shortened. Thus, by using the fusion splicer equipped with the rotator 40, rotation alignment and fusion splicing can be performed even when the length of the optical fiber 25 is short.

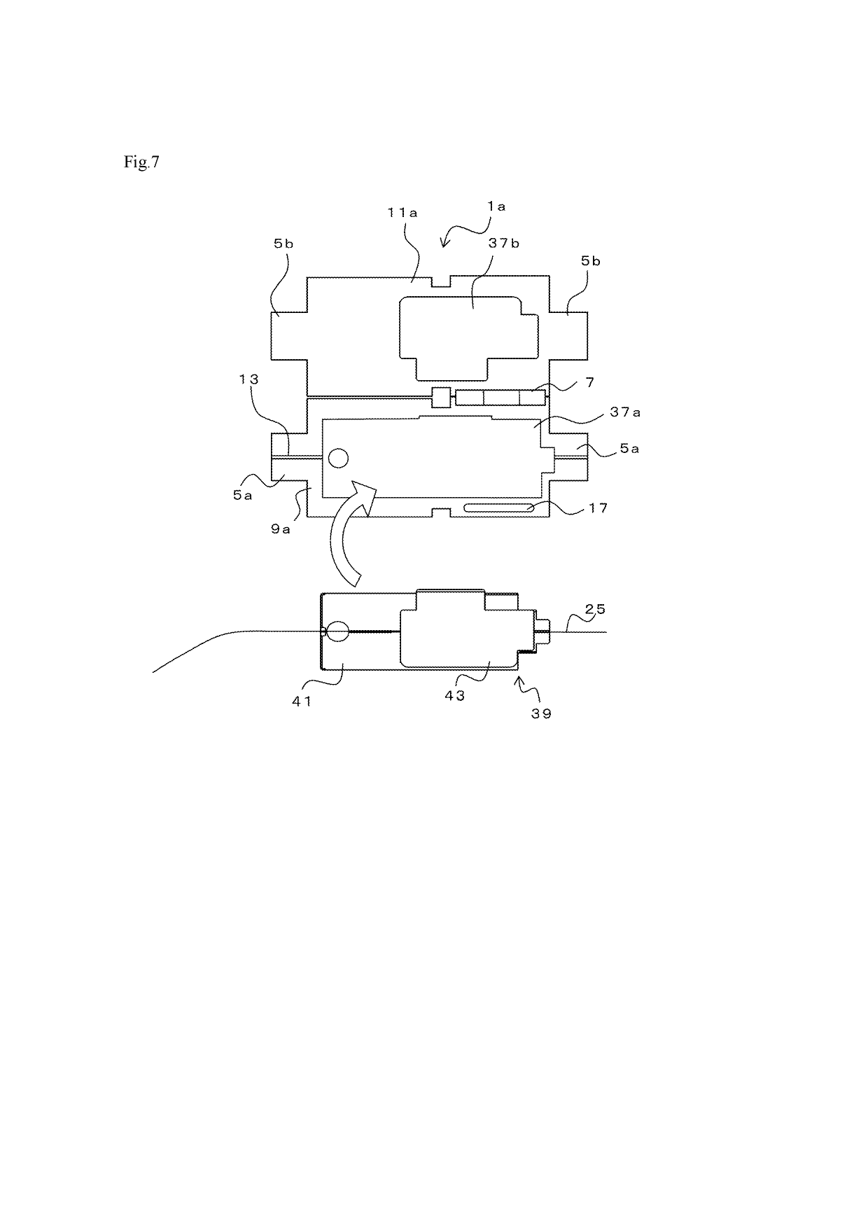

Next, a second embodiment will be described. FIG. 7 is a view showing an optical fiber holding portion 1a according to the second embodiment. In the descriptions hereafter, the same notations will be given to structures similar to those described in the above embodiment and redundant explanations will be omitted.

The second embodiment has approximately the similar structure as the first embodiment, except that the optical fiber 25 is fixed and held by an optical fiber holder 39, which is similar to the conventional one. The optical fiber holder 39 includes a main body 41 and a lid portion 43, and the optical fiber 25 is held by closing the lid portion 43. There is no particular limitation for a shape of the optical fiber holder 39, and any known optical fiber holder can be used.

The optical fiber holding portion 1a includes a holding-portion main body 9a and a holding-portion lid 11a, which can be opened and closed against one another. When the holding-portion main body 9a and the holding-portion lid 11a are closed, the optical fiber holding portion 1a has the same outer surface shape as the above-mentioned optical fiber holder 1.

On an inner surface side of the holding-portion main body 9a, a concave portion 37a corresponding to a shape of the main body 41 of the optical fiber holder 39 is formed. Also, on an inner surface side of the holding-portion lid 11a, a concave portion 37b corresponding to a shape of the lid portion 43 of the optical fiber holder 39 is formed. The concave portions 37a and 37b form a space for accommodating the optical fiber holder 39 inside the optical fiber holding portion 1a. That is, the optical fiber holding portion 1a can accommodate therein the optical fiber holder 39 for holding the optical fiber 25.

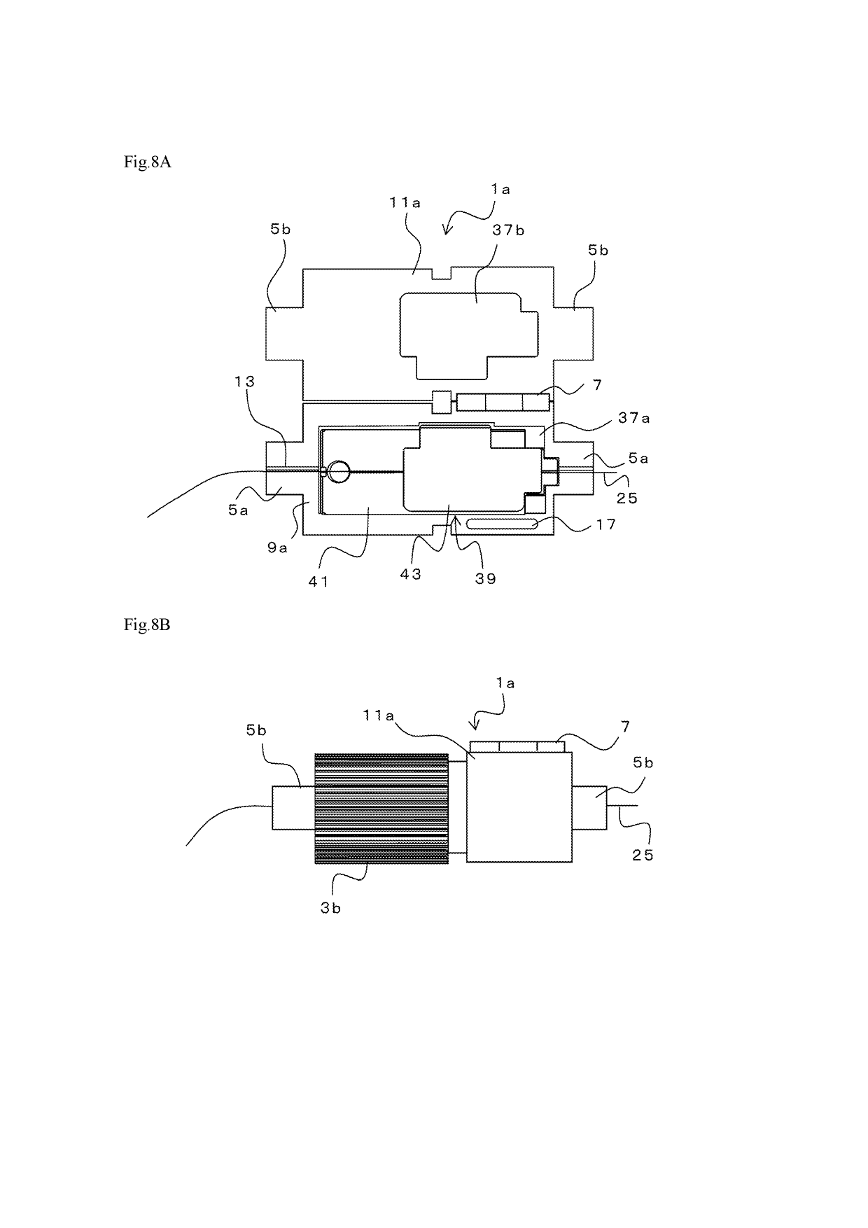

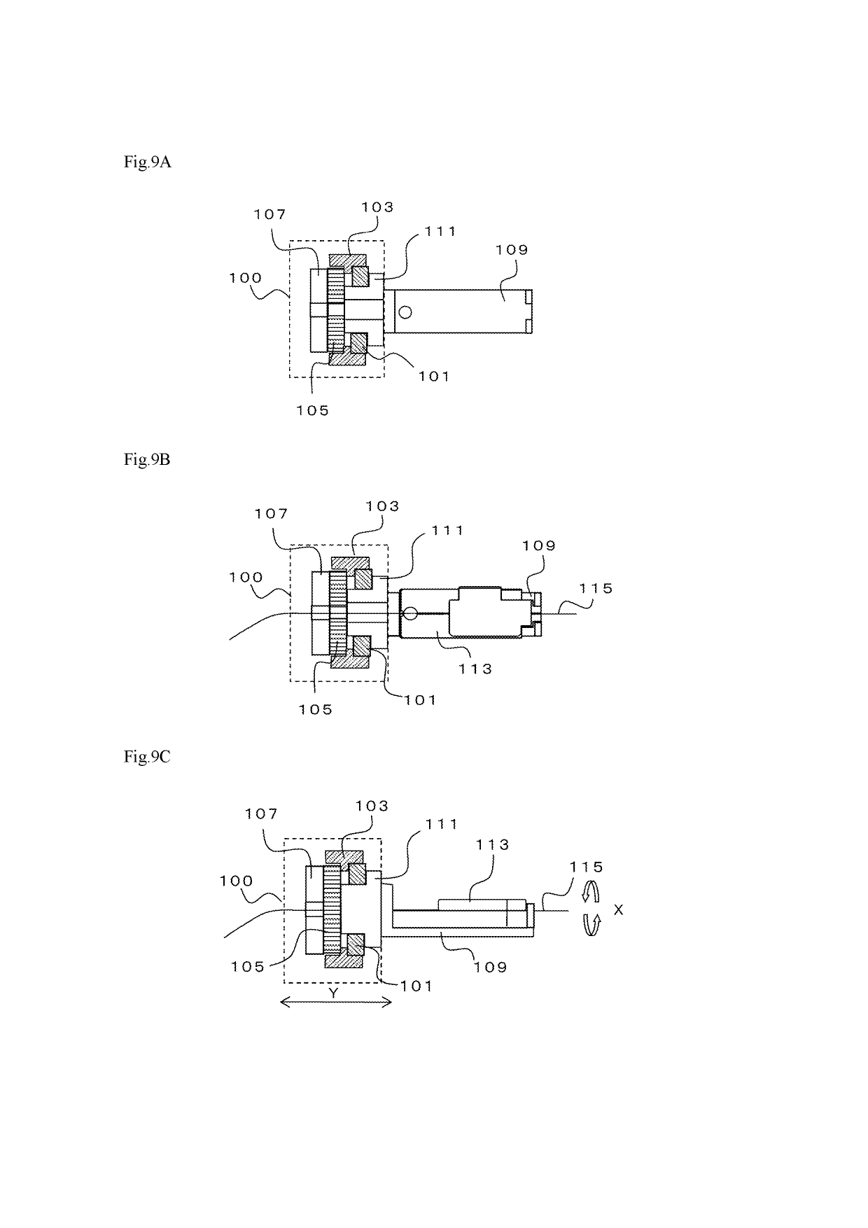

FIG. 8A is a view showing a state in which the optical fiber holder 39 is disposed in the concave portion 37a of the holding-portion main body 9a, and FIG. 8B is a view showing a state in which the holding-portion lid 11a is closed. In the concave portion 37a of the holding-portion main body 9a, a pin for positioning the optical fiber holder 39 is disposed, and thus the optical fiber holder 39 can be positioned and fixed to the holding-portion main body 9a.

By accommodating the optical fiber holder 39 in the holding-portion main body 9a and closing the holding-portion lid 11a, the optical fiber holding portion 1a can hold the optical fiber holder 39. Note that a part of the optical fiber 25 protruding in front and back of the optical fiber holder 39 is disposed in the V-groove 13 of the holding-portion main body 9a, for example.

In this way, the optical fiber holding portion 1a equipped with the optical fiber holder 39 can be used in the same way as the above-mentioned optical fiber holder 1. That is, by setting the optical fiber holding portion 1a in the fusion-splicer main body 19 (the rotator 40) and driving the motor 29, the optical fiber holder 39 can be rotated along with the optical fiber holding portion 1a.

According to the second embodiment, the same effects as in the first embodiment can be obtained. Also, the optical fiber holder 39 can be accommodated inside the optical fiber holding portion 1a, and thus it is possible to utilize the conventionally used optical fiber holder 39 as is. Thus, it is possible to use an optical fiber cutter or stripper as is.

Similarly to the optical fiber holder 1, in the optical fiber holding portion 1a, the holding-portion main body 9a and the holding-portion lid 11a may not be joined by the hinge 7 and may be completely separated. Also, the magnet 17 may not be used for fixing between the holding-portion main body 9a and the holding-portion lid 11a.

Also, in the above-mentioned fusion splicer, an example in which at least one of the pair of optical fibers 25 disposed facing each other is disposed in the rotator 40 has been described. However, if a plurality of optical fibers facing each other are to be disposed facing each other, the rotator 40 may be provided for each pair of the optical fibers that are disposed facing each other. That is, a plurality of the rotators 40 may be arranged in parallel.

As above, although the embodiments of the present invention have been described referring to the attached drawings, the technical scope of the present invention is not limited to the embodiments described above. It is obvious that persons skilled in the art can think out various examples of changes or modifications within the scope of the technical idea disclosed in the claims, and it will be understood that they naturally belong to the technical scope of the present invention.

What is claimed is:

1. An optical fiber rotator comprising:
an optical fiber holding portion for holding an optical fiber;
a gear portion formed on an outer periphery surface of the optical fiber holding portion; and
a driving portion that is capable of rotating the gear portion,
wherein the optical fiber rotator is capable of rotating the optical fiber holding portion with an axis direction of the optical fiber as a rotation axis.

2. The optical fiber rotator according to claim 1, wherein:
the optical fiber holding portion is an optical fiber holder having a main body and a lid portion;
the optical fiber can be held by being disposed in the main body and by closing the lid portion; and
the gear portion is provided on an outer periphery surface of the optical fiber holder.

3. The optical fiber rotator according to claim 1, wherein an optical fiber holder for holding the optical fiber can be accommodated inside the optical fiber holding portion, and the optical fiber holder can be rotated together with the optical fiber holding portion.

4. The optical fiber rotator according to claim 3, wherein the optical fiber holding portion includes a holding-portion main body and a holding-portion lid, and the holding-portion lid can be opened and closed with respect to the holding-portion main body.

5. A fusion splicer equipped with the optical fiber rotator according to claim 1, wherein:
at least one of a pair of optical fibers that are disposed facing each other is held by the optical fiber rotator; and
an axis receiving portion supports the optical fiber holding portion to a fusion-splicer main body.

6. The fusion splicer according to claim 5, wherein the driving portion is disposed on a fusion-splicer lid that can be opened and closed with respect to the fusion-splicer main body, and the driving portion and the gear portion of the optical fiber holding portion are connected to each other by closing the fusion-splicer lid.

7. An optical fiber holder that is capable of holding an optical fiber, the optical fiber holder comprising:
a main body on which the optical fiber is to be disposed; and
a lid portion that can be opened and closed with respect to the main body,
wherein when the lid portion is closed onto the main body, a gear portion in which a plurality of teeth are arranged in a circumferential direction is formed on outer periphery surfaces of the main body and the lid portion.

8. A fusion splicer equipped with the optical fiber rotator according to claim 2, wherein:
at least one of a pair of optical fibers that are disposed facing each other is held by the optical fiber rotator; and
an axis receiving portion supports the optical fiber holding portion to a fusion-splicer main body.

9. The fusion splicer according to claim 8, wherein the driving portion is disposed on a fusion-splicer lid that can be opened and closed with respect to the fusion-splicer main body, and the driving portion and the gear portion of the optical fiber holding portion are connected to each other by closing the fusion-splicer lid.

10. A fusion splicer equipped with the optical fiber rotator according to claim 3, wherein:
at least one of a pair of optical fibers that are disposed facing each other is held by the optical fiber rotator; and
an axis receiving portion supports the optical fiber holding portion to a fusion-splicer main body.

11. The fusion splicer according to claim 10, wherein the driving portion is disposed on a fusion-splicer lid that can be opened and closed with respect to the fusion-splicer main body, and the driving portion and the gear portion of the optical fiber holding portion are connected to each other by closing the fusion-splicer lid.

12. A fusion splicer equipped with the optical fiber rotator according to claim 4, wherein:
at least one of a pair of optical fibers that are disposed facing each other is held by the optical fiber rotator; and
an axis receiving portion supports the optical fiber holding portion to a fusion-splicer main body.

13. The fusion splicer according to claim 12, wherein the driving portion is disposed on a fusion-splicer lid that can be opened and closed with respect to the fusion-splicer main body, and the driving portion and the gear portion of the optical fiber holding portion are connected to each other by closing the fusion-splicer lid.
